(19) United States
(12) Patent Application Publication
(10) Pub. No.: US 2018/0037384 A1
(43) Pub. Date: Feb. 8, 2018

(54) CONTAINER WITH SEALING AREA IN FINISH PORTION

(71) Applicant: GRAHAM PACKAGING COMPANY, L.P., Lancaster, PA (US)

(72) Inventors: Armel Archeny, Briord (FR); David Araujo, Jassans-Riottier (FR)

(73) Assignee: GRAHAM PACKAGING COMPANY, L.P., Lancaster, PA (US)

(21) Appl. No.: 15/784,610

(22) Filed: Oct. 16, 2017

Related U.S. Application Data
(63) Continuation of application No. PCT/IB2015/000639, filed on Apr. 17, 2015.

(51) Int. Cl. B65D 53/04; B29C 49/00; A47J 47/04; B29C 49/04; B65D 43/02; B65D 1/44

(52) U.S. Cl. CPC B65D 53/04; B65D 43/0204; B65D 43/0225; B65D 1/44; A47J 47/04; B29C 49/04; B29C 49/0078; B29C 2049/4294

(57) ABSTRACT

Blow-molded plastic container is provided having a main body portion (102), a finish portion (110) and a sealing lip (130). The main body portion includes a bottom region (104) defining a support reference plane and an upstanding sidewall (106) defining a body portion chamber (108) and a perimeter of the main body portion. The finish portion (110) is disposed proximate an upper region of the main body portion opposite the bottom region and defines a finish portion chamber (108) and an opening (116) in communication with body portion chamber. The finish portion is configured to engage a lid member (150,250). The sealing lip (130) is disposed between the main body portion and the finish portion. The sealing lip extends inwardly from the perimeter of the main body portion and is configured to receive a sealing member (140) to seal the opening between the body portion chamber and the finish portion chamber.

### BACKGROUND

### Field of the Disclosed Subject Matter

The present disclosed subject matter relates to plastic containers. Particularly, the present disclosed subject matter is directed to a plastic container to hold a liquid, powdered or granulated product, such as a food product or the like, particularly wherein the container has a sealing area for a sealing member to isolate a finish portion chamber from a body portion chamber.

### Description of Related Art

Plastic containers, for example canisters, can be used for packaging of a wide variety of products, and are available in a wide range of sizes and shapes. It can be desirable for certain products, including liquid, powdered and granulated products, such as food products, to be packaged and stored in containers having a reliable and secure seal formed between the container and the lid. Such a seal can prevent spoilage of the contents of the container, for example by preventing moisture or other unwanted elements from entering the container during transportation and storage. Such containers can also be configured for increased reliability and durability under extreme temperature conditions and for prolonged periods of storage.

Numerous types of closures to seal such containers have been developed, including for example and without limitation, threaded closures, friction fit and snap fit closures, and thermosealed closures. Many of these closures can be re-sealable on a container. Resealable closures can allow the closure to be replaced on the container if all of the container contents have not been dispensed. Thus, such containers can contain more than a single use amount of material, resulting in decreased packaging costs. Additionally, such containers can be refilled and reused, if desired.

Certain containers, such as canisters, conventionally have been fabricated from steel or other metallic materials. Although, plastic materials for such containers have been investigated, such plastic containers using conventional finish configurations can be difficult to seal with suitable results.

Furthermore, certain products packaged in plastic containers, including powdered and granulated products, can be intended to be used in a measured quantity. Often, a measuring device, for example a measuring cup or spoon, can be packaged within the body of the container with the powdered or granulated product. The measuring device thus can be accessed once a sealing member is removed. However, the measuring device can become buried within the powdered or granulated product, and therefore difficult to access.

It therefore is desirable to provide a plastic container having a reliable and secure seal and increased reliability and durability for packaging and storing of powdered or granulated products, such as food products. It is also desirable to provide such a plastic container with a complementary item, such as an additional measuring device, that can be stored within the plastic container, but separate from the other contents.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes a blow-molded plastic container including a main body portion, a finish portion and a sealing lip. The main body portion includes a bottom region defining a support reference plane and an upstanding sidewall defining a body portion chamber and a perimeter of the main body portion. The finish portion is disposed proximate an upper region of the main body portion opposite the bottom region and defines a finish portion chamber and an opening in communication with body portion chamber. The finish portion is configured to engage a lid member. The sealing lip is disposed between the main body portion and the finish portion. The sealing lip extends inwardly from the perimeter of the main body portion and is configured to receive a sealing member to seal the opening between the body portion chamber and the finish portion chamber.

Additionally, and as embodied herein, the container can include a plurality of circumferential ribs formed in the sidewall. The sealing lip can be formed as a fold between the main body portion and the finish portion. The sealing lip can be V-shaped in transverse cross section. An upper segment of the fold can extend upwardly at an angle of about 15 degrees relative to the reference plane. Additionally or alternatively, an upper segment of the fold can have a tapered wall thickness. A lower segment of the fold can extend downwardly at an angle of about 5 degrees relative to the reference plane. Additionally or alternatively, a lower segment of the fold can have a tapered wall thickness. The fold can extend inwardly a distance of about 5 mm from the sidewall of the main body portion.

Furthermore, and as embodied herein, the container can include a lid removably engaged to the finish portion. The finish portion can include a thread to threadedly engage the lid. Additionally or alternatively, the finish portion can include a ridge to snap engage the lid.

In addition, and as embodied herein, the container can include a sealing member secured to the sealing lip. The sealing member can include a sheet of foil or film. The sealing member can be secured to the sealing lip with an adhesive. The container can include an item disposed in the finish portion chamber and isolated from the body portion chamber.

Additionally, and as embodied herein, the sidewall and the finish portion define a generally cylindrical shape. An outer surface of the sidewall proximate the sealing lip can be substantially perpendicular to the reference plane. Additionally or alternatively, the sidewall can have a maximum transverse dimension greater than a maximum transverse dimension of the finish portion. The main body portion can include a transition region between the sidewall and the sealing lip. The transition region can include an angled transition portion extending inwardly and upwardly from an upper end of the sidewall to the sealing lip. The angled transition portion can have a tapered wall thickness. The main body portion can include a radiused portion between the sidewall and the angled transition portion. Additionally or alternatively, the main body portion can include a radiused portion between the angled transition portion and the sealing lip.

The disclosed subject matter also includes a method of making a blow-molded plastic container having some or all of the features described herein. As recognized in the art, the blow-molded plastic container disclosed herein can include some or all of the features described herein, or any suitable combination thereof.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE DRAWINGS

FIG. 1 is a perspective view of an exemplary embodiment of a blow-molded plastic container in accordance with the disclosed subject matter.

FIG. 2 is a front view of the container of FIG. 1.

FIG. 3 is an enlarged, cross-sectional transverse view of Region 3 of the container of FIG. 2.

FIG. 4 is an enlarged, cross-sectional, perspective view of Region 4 of the container of FIG. 2, showing a sealing member engaged to the sealing lip.

FIG. 5 is a perspective view of the container of FIG. 1, showing a lid engaged to the finish portion.

FIG. 6 is a perspective view of another exemplary embodiment of a blow-molded plastic container in accordance with the disclosed subject matter.

FIG. 7 is a front view of the container of FIG. 6.

FIG. 8 is an enlarged, cross-sectional, transverse view of Region 8 the container of FIG. 7.

FIG. 9 is an enlarged, cross-sectional, perspective view of Region 9 of the container of FIG. 7, showing a sealing member engaged to the sealing lip.

FIG. 10 is a perspective view of the container of FIG. 6, showing a lid engaged to the finish portion.

### DETAILED DESCRIPTION OF THE PREFERRED EMBODIMENT

Reference will now be made in detail to the various exemplary embodiments of the disclosed subject matter, exemplary embodiments of which are illustrated in the accompanying drawings. The structure and corresponding methods of making and using the disclosed subject matter will be described in conjunction with the detailed description of the container.

The apparatus and methods presented herein can be used for packaging, storage and transport of perishable or nonperishable food products. The disclosed subject matter is particularly suited for packaging, storing, and dispensing powdered or granulated food products.

In accordance with the disclosed subject matter herein, the container generally includes a blow-molded plastic container including a main body portion, a finish portion and a sealing lip. The main body portion includes a bottom region defining a support reference plane and an upstanding sidewall defining a body portion chamber and a perimeter of the main body portion. The finish portion is disposed proximate an upper region of the main body portion opposite the bottom region and defines a finish portion chamber and an opening in communication with body portion chamber. The finish portion is configured to engage a lid member. The sealing lip is disposed between the main body portion and the finish portion. The sealing lip extends inwardly from the perimeter of the main body portion and is configured to receive a sealing member to seal the opening between the body portion chamber and the finish portion chamber.

The accompanying figures, where like reference numerals refer to identical or functionally similar elements throughout the separate views, serve to further illustrate various embodiments and to explain various principles and advantages all in accordance with the disclosed subject matter. Additionally, as used herein, the terms “front,” “rear,” “side,” “top,” and “bottom” are used for the purpose of illustration only, and not limitation. That is, it is recognized that the terms “front,” “rear,” “side,” “top,” and “bottom” are interchangeable and are merely used herein as a point of reference.

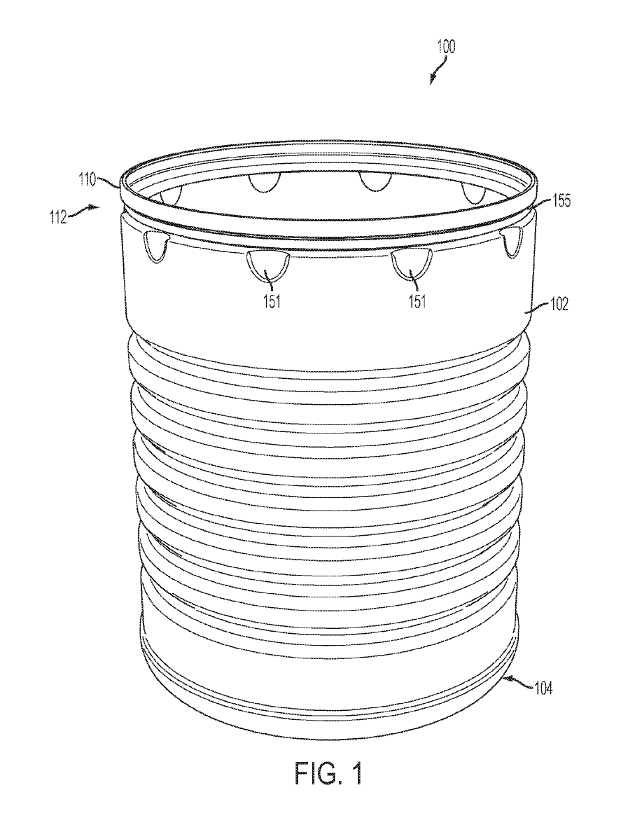

For purpose of explanation and illustration, and not limitation, exemplary embodiments of the container in accordance with the disclosed subject matter are shown in FIGS. 1-10. The container is suitable for use with a wide variety of food products, including fresh food products, dried foods, processed foods and liquids. However, the container disclosed herein is particularly suitable and beneficial for use with powdered or granulated food products, such as powdered milk, ground coffee, instant breakfast mixes, non-dairy creamer, instant soup, dehydrated potatoes, rice, and grains, wherein the container can be used for storing, transporting, and/or re-using such food products as well as serving the food products and allowing for measurement of the food products. The container desirably can have insulating properties to assist in maintaining the temperature of food contained therein as well as prevent moisture from entering the container.

Further, for purpose of illustration, and not limitation, reference will made herein to a container intended to contain food products in a body portion chamber, as well as hold a second item or device, if desired, in a finish portion chamber. As discussed below, the additional item or device can be a number of items, such as a measuring device, serving device, gadget or toy, either for use with the container or container contents, related to the container contents or unrelated to the container contents.

With reference to FIGS. 1-5, for purpose of illustration, and not limitation, the container 100 generally includes a main body portion 102 having a bottom region 104 defining a support reference plane P₁ and an upstanding sidewall 106 defining a body portion chamber 108 and a perimeter of the main body portion 102.

Sidewall 106 can include one or more surface features, such as a single or a plurality of ribs formed therein. As embodied herein, and with reference to FIG. 1, sidewall 106 can include a plurality of ribs 120 formed therein. For purpose of illustration, and not limitation, ribs 120 can be spaced from the upper region 112 and the bottom region 104. Additionally or alternatively, ribs 120 can be evenly spaced apart from each other along the sidewall 106. Sidewall 106 can include any suitable number of ribs 120, and can be configured to reinforce the sidewall 106 and resist paneling, dents and other unwanted deformation of the sidewall 106. As a further alternative, sidewall 106 can be free of ribs or other surface features between the upper region 112 and the bottom region 104. Additional surface features can be provided, such as but not limited to, arcuate recesses 151 along the upper edge of sidewall 106 for gripping or the like.

Additionally, and as embodied herein, container 100 includes a finish portion 110 disposed proximate an upper region 112 of the main body portion 102 opposite the bottom region 104. As described further below, the finish portion 110 defines a finish portion chamber 114 and an opening 116 in communication with body portion chamber 108. As embodied herein, the finish portion 110 is configured to engage a lid member 150 or the like, if provided.

Furthermore, and as embodied herein, container 100 includes a sealing lip 130 disposed between the main body portion 102 and the finish portion 110. The sealing lip 130 extends inwardly from the perimeter of the main body portion 102. The sealing lip 130 is configured to receive a sealing member 140 to seal the opening between the body portion chamber 108 and the finish portion chamber 114.

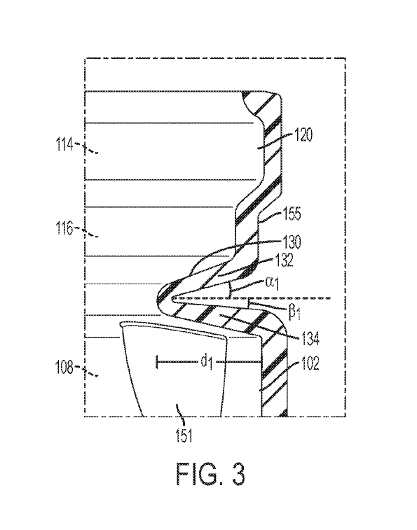

With reference to FIG. 3, as embodied herein, the sealing lip 130 can be configured as a fold between the main body portion 102 and the finish portion 110. For example, and as embodied herein, the fold forming sealing lip 130 can be V-shaped. An upper segment 132 of the sealing lip 130 can extend upwardly at an angle α₁ relative to the reference plane P₁. For purpose of illustration and not limitation, angle α₁ can be between 10 degrees and 15 degrees, and as embodied herein angle α₁ can be 15 degrees. A lower segment 134 of the sealing lip 130 can extend downwardly at an angle β₁ relative to the reference plane P₁, and which can depend at least in part on the weight and/or stretch of the parison in a blow-molding process, if utilized. For purpose of illustration and not limitation, angle β₁ can be within a range of 5 degrees to 20 degrees, and as embodied herein, angle β₁ can be 5 degrees. The sealing lip 130 can extend inwardly a distance d from the perimeter of the main body portion 102, and as embodied herein distance d₁ can be about 5 mm.

Referring still to FIG. 3, the segments of the sealing lip 130 can have a tapered wall thickness. For example, and as embodied herein, the wall thickness of upper segment 132 can decrease from sidewall 106 toward an end of the sealing lip 130, proximate an intersection with lower segment 134. Additionally or alternatively, as embodied herein, the wall thickness of lower segment 134 can decrease from sidewall 106 toward an end of the sealing lip 130, proximate an intersection with upper segment 132.

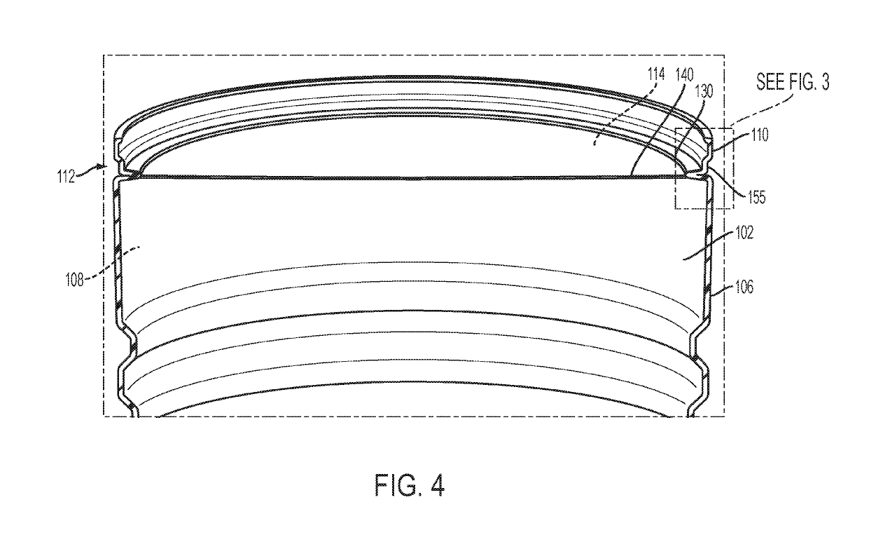

Referring now to FIG. 4, as embodied herein, container 100 can include a sealing member 140 secured to the sealing lip 130. In this manner, sealing member 140 can seal opening 116 to isolate finish portion chamber 114 from body portion chamber 108. The sealing member 140 can be formed from any suitable material to isolate finish portion chamber 114 from body portion chamber 108. For purpose of illustration and not limitation, as embodied herein, sealing member 140 can be formed from a sheet of foil or film. For example, sealing member 140 can be formed from plastic, paper, metal or any other suitable material. The sealing member 140 can be secured to the sealing lip 130 using any suitable sealing technique. For purpose of illustration and not limitation, as embodied herein, sealing member 140 can be secured to the sealing lip 130 with an adhesive. Additionally or alternatively, sealing member 140 can be secured to sealing lip 130 by welding, bonding, press-fit or friction-fit engagement, threaded engagement or any other suitable engagement depending upon the materials used. The sealing member 140 can be secured so as to be readily releasable, such as by a pull tab, or secured more durably so as to require a perforation, or line or weakness or other frangible technique to access the body portion chamber 108.

Additionally, and as embodied herein, container 100 can include a main product disposed in body portion chamber 108. For purpose of illustration, and not limitation, the main product disposed in the body portion chamber 108 can be a powdered or granulated food product, such as powdered milk, ground coffee, instant breakfast mix, non-dairy creamer, instant soup, dehydrated potatoes, rice, or grains. Additionally, container 100 can include an additional item disposed in the finish portion chamber 114, isolated from the body portion chamber 108. In some embodiments, the additional item can be a complementary item for use with the main product. For example, and not limitation, the additional item can be a measuring cup or spoon. Additionally or alternatively, the additional item can be a gadget or toy, which can be related or unrelated to the main product. Container 100 can include one or more additional items in the finish portion chamber 114.

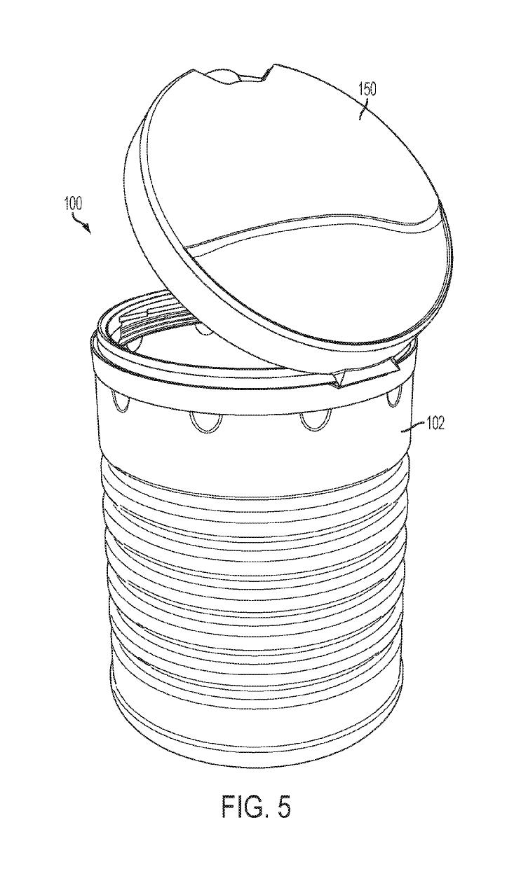

Referring now to FIG. 5, container 100 can include a lid 150 engaged to the finish portion 110. Lid 150 can be any suitable configuration. For example, and as embodied herein, lid 150 can include a hinge to allow hinged opening and closing of lid 150 relative finish portion chamber 114 without removing lid 150 from finish portion 110. Finish portion 110 can include any suitable engagement to engage lid 150. For purpose of illustration, and as embodied herein, finish portion 110 can include a ridge 155 to snap engage lid 150. Additionally or alternatively, lid 150 can include a hinged engagement or a threaded engagement to finish portion 110.

In operation, a user can open or remove lid 150 as appropriate to access finish portion chamber 114. The user can remove any additional item or device contained in finish portion chamber 114. The user can detach sealing member 140 from sealing lip 130 or rupture the sealing member 140 if appropriate. For example, the user can peel away or puncture sealing member 140 to remove at least a portion of sealing member 140 to access body chamber portion 102. In some embodiments, sealing member 140 can be disposed once removed from container 100. Alternatively, sealing member 140 can be reattached to sealing lip 130 to re-seal opening 116. In this manner, the additional product can be replaced into finish portion chamber 114. Lid 150 can be closed to cover finish portion chamber 114 for future use.

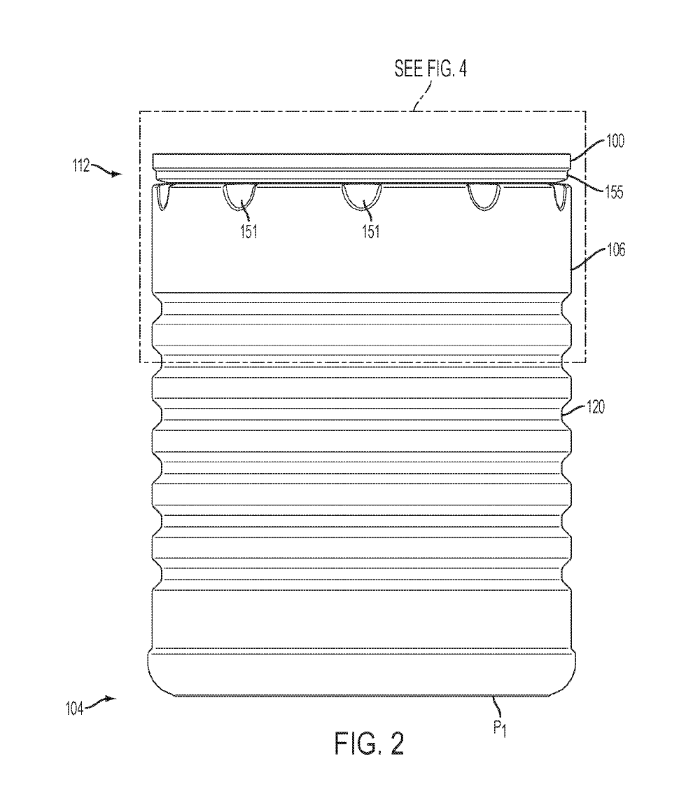

With reference to the upper portion of the container embodied herein, as shown in FIGS. 2 and 3, an outer surface of the sidewall 106 of the main body portion 102 can be substantially perpendicular to the reference plane P1 proximate the finish portion 110. Additionally or alternatively, as embodied herein, sidewall 106 can be substantially aligned with at least a portion of the finish portion 110 with the sealing lip 130 disposed therebetween. As such, for purpose of illustration, and as embodied herein, sidewall 106 and finish portion 110 individually or collectively can define a generally cylindrical shape. Particularly, sidewall 106 and finish portion 110 together can define a container having a uniform, cylindrical shape.

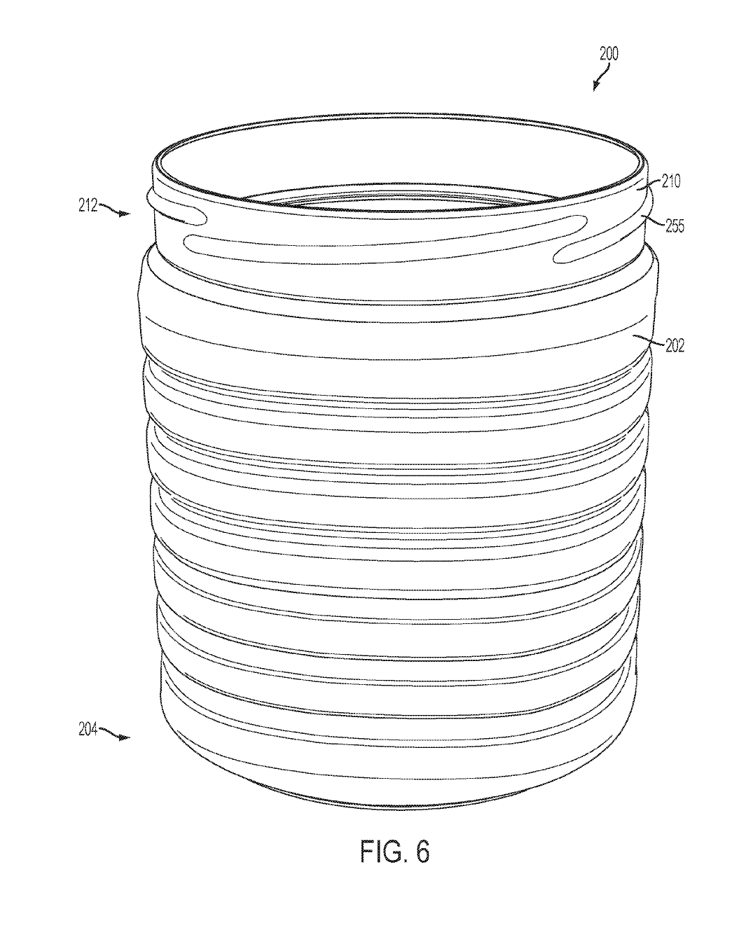

For purpose of illustration, and not limitation, reference is made to another exemplary embodiment of a container 200 shown in FIGS. 6-10. As shown in FIGS. 6-10, the container 200 generally includes a main body portion 202 having a bottom region 204 defining a support reference plane P₂ and an upstanding sidewall 206 defining a body portion chamber 208 and a perimeter of the main body portion 202.

As with the embodiment of FIGS. 1-5, sidewall 206 can include one or more surface features, such as a single rib or a plurality of ribs formed therein. As embodied herein, and with reference to FIG. 6, sidewall 206 can include a plurality of ribs 220 formed therein. For purpose of illustration, and not limitation, ribs 220 can be spaced from the upper region 212 and the bottom region 204. Additionally or alternatively, ribs 220 can be evenly spaced apart from each other along the sidewall 206. Sidewall 206 can include any suitable number of ribs 220, and can be configured to reinforce the sidewall 206 and resist paneling, dents and other unwanted deformation of the sidewall 206. As a further alternative, sidewall 206 can be free of ribs or other surface features between the upper region 212 and the bottom region 204.

Additionally, and as embodied herein, container 200 includes a finish portion 210 disposed proximate an upper region 212 of the main body portion 202 opposite the bottom region 204. As described further below, the finish portion 210 defines a finish portion chamber 214 and an opening 216 in communication with body portion chamber 208. As embodied herein, the finish portion 210 is configured to engage a lid member 250.

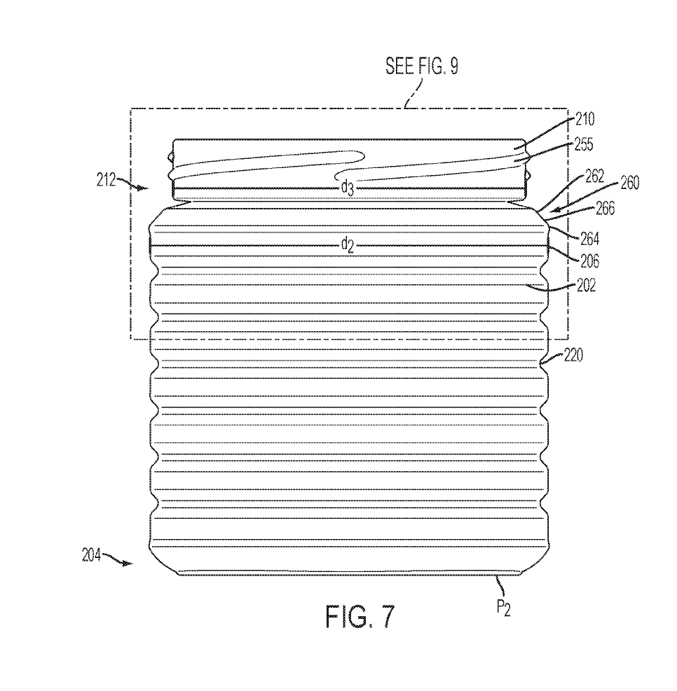

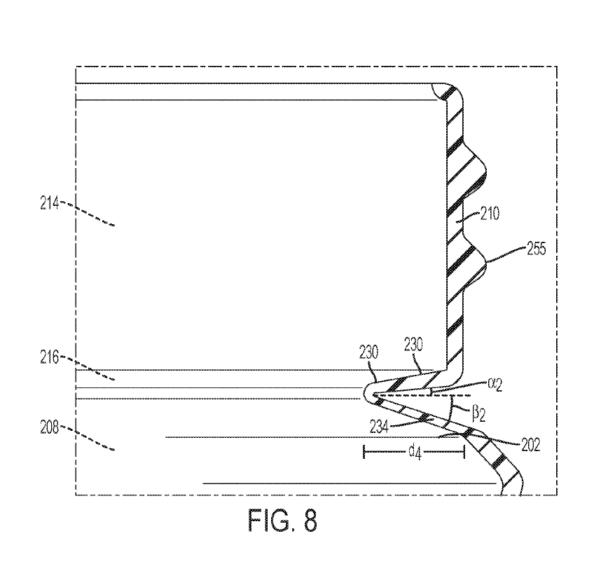

In accordance with another aspect of the disclosed subject matter, with reference to FIGS. 7 and 8, as embodied herein, sidewall 206 can have a maximum transverse dimension d₂ greater than a maximum transverse dimension d₃ of the finish portion. For purpose of illustration, and not limitation, dimension d₂ can be about 10% greater than d₃. The main body portion can include an angled transition portion 260 between the sealing lip 230 and the sidewall 206. For purpose of illustration, and as embodied herein, angled transition region 260 can include a first radiused portion 262 extending at a first angle from sealing lip 230. Additionally, and as embodied herein, angled transition region 260 can include a substantially flat transition surface 266 extending from the first radiused portion 262 to a second radiused portion 264. The second radiused portion 264 can extend at a second angle from the transition surface 266 to the sidewall 206. In this manner, the sidewall 206 and angled transition region 260 can define a rounded shape of the main body portion 202 in plan view.

Furthermore, and as embodied herein, container 200 includes a sealing lip 230 disposed between the main body portion 202 and the finish portion 210. The sealing lip 230 extends inwardly from the perimeter of the main body portion 202. The sealing lip 230 is configured to receive a sealing member 240 to seal the opening between the body portion chamber 208 and the finish portion chamber 214.

With reference to FIG. 8, as embodied herein, the sealing lip 230 can be formed as a fold between the main body portion 202 and the finish portion 210. For example, and as embodied herein, the fold forming sealing lip 130 can be V-shaped. An upper segment 232 of the sealing lip 230 can extend upwardly at an angle α₂ relative to the reference plane P₂. For purpose of illustration and not limitation, angle α₂ can be between 10 degrees and 15 degrees, and as embodied herein angle α₂ can be 15 degrees. A lower segment 234 of the sealing lip 230 can extend downwardly at an angle β₂ relative to the reference plane P₂, and which can depend at least in part on the weight and/or stretch of the parison in a blow-molding process, if utilized. For purpose of illustration and not limitation, angle β₂ can be within a range of 5 degrees to 20 degrees, and as embodied herein, angle β₂ can be 5 degrees. The sealing lip 230 can extend inwardly a distance d₄ from the perimeter of the main body portion 202, and as embodied herein distance d₁ can be about 5 mm.

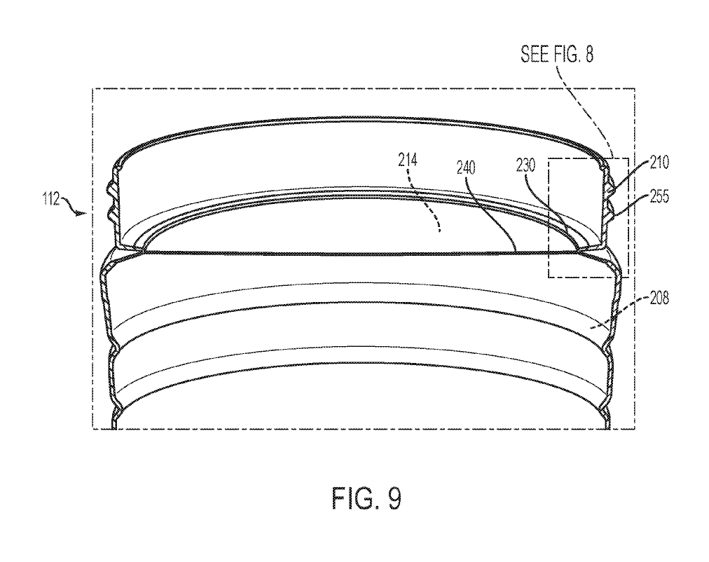

Referring now to FIG. 9, as embodied herein, container 200 can include a sealing member 240 secured to the sealing lip 230. In this manner, sealing member 240 can seal opening 216 to isolate finish portion chamber 214 from body portion chamber 208. The sealing member 240 can be formed from any suitable material to isolate finish portion chamber 214 from body portion chamber 208. For purpose of illustration and not limitation, as embodied herein, sealing member 240 can be formed from a sheet of foil or film. For example, sealing member 240 can be formed from plastic, paper, metal or any other suitable material. The sealing member 240 can be secured to the sealing lip 230 using any suitable sealing technique. For purpose of illustration and not limitation, as embodied herein, sealing member 240 can be secured to the sealing lip 230 with an adhesive. Additionally or alternatively, sealing member 240 can be secured to sealing lip 230 by welding, bonding, press-fit or friction-fit engagement, threaded engagement or any other suitable engagement.

Additionally, and as embodied herein, container 200 can include a main product disposed in body portion chamber 208. For purpose of illustration, and not limitation, the main product disposed in the body portion chamber 208 can be a powdered or granulated food product. Additionally, container 200 can include an additional item disposed in the finish portion chamber 214, isolated from the body portion chamber 208. Container 200 can include one or more additional items in the finish portion chamber 214.

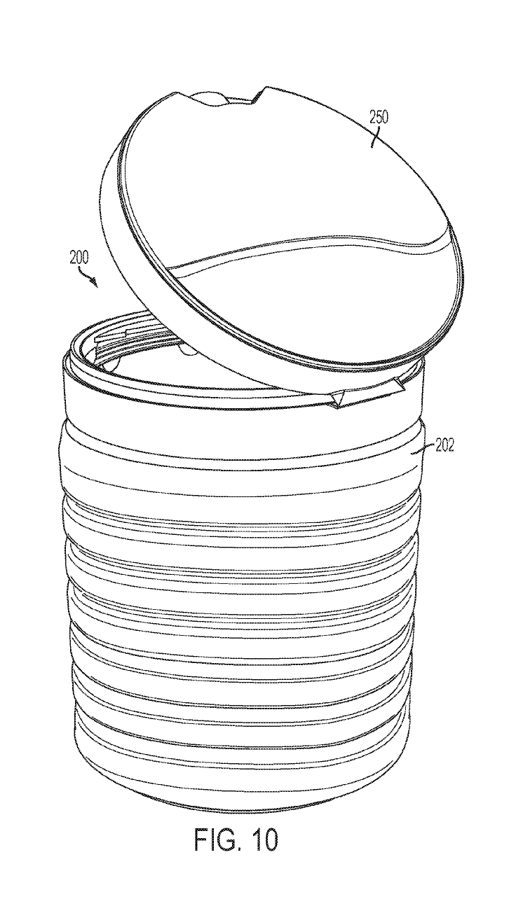

Referring now to FIG. 10, container 200 can include a lid 250 engaged to the finish portion 210. Lid 250 can be any suitable configuration. For example, and as embodied herein, lid 250 can include a hinge to allow hinged opening and closing of lid 250 relative finish portion chamber 214 without removing lid 250 from finish portion 210. Finish portion 210 can include any suitable engagement to engage lid 250. For purpose of illustration, and as embodied herein, finish portion 210 can include a ridge 255 to snap engage lid 250. Additionally or alternatively, lid 250 can include a hinged engagement or a threaded engagement to finish portion 210.

In operation, a user can open or remove lid 250 as appropriate to access finish portion chamber 214. The user can remove any additional item included in finish portion chamber 214. The user can detach sealing member 240 from sealing lip 230 or rupture sealing member 230 if appropriate. For example, the user can peel away or perforate sealing member 240 to remove at least a portion of sealing member 240 to access body chamber portion 202. In some embodiments, sealing member 240 can be disposed once removed from container 200. Alternatively, sealing member 240 can be reattached to sealing lip 230 to re-seal opening 216. In this manner, the additional product can be replaced into finish portion chamber 214. Lid 250 can be closed to cover finish portion chamber 214 for future use.

Containers disclosed herein can be manufactured by any suitable process. For purpose of illustration and not limitation, and as embodied herein, containers disclosed herein are manufactured by a blow-molding process, including an extrusion blow molding process. Generally, the molding process will include two or more mold components having an inner mold surface generally corresponding to the desired shape of the container, as described herein. That is the inner mold surface will have corresponding surface features to form the outer surface of the main body portion, the sealing lip and the finish portion, respectively. The pressure and temperature of the materials to be blow molded will be controlled to provide the desired wall thickness as known in the art. Additional details of exemplary blow-molding techniques are described in U.S. Patent Application Publication No. 2012/0007289, which is incorporated by reference herein in its entirety.

Containers disclosed herein can be manufactured using any suitable materials. For example and not limitation, containers disclosed herein can be formed from PET, rPET, polypropylene, HDPE or other polymeric materials.

It is to be recognized that the dimensions and relative proportions of the main body portion, finish portion, sealing lip, etc. of the containers disclosed herein will vary according to the exact size and intended use of the containers. While generally cylindrical containers are illustrated in FIGS. 1-10, one of ordinary skill will recognize that any suitable shape and depth of food container can be employed and the disclosed subject matter is not so limited. Other suitable shapes include triangles, cones, ovals, various polygons, etc., having any suitable dimensions.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

1. A blow-molded plastic container comprising:
a main body portion having a bottom region defining a support reference plane and an upstanding sidewall defining a body portion chamber and a perimeter of the main body portion;
a finish portion disposed proximate an upper region of the main body portion opposite the bottom region, the finish portion defining a finish portion chamber and an opening in communication with body portion chamber, the finish portion configured to engage a lid member; and
a sealing lip between the main body portion and the finish portion, the sealing lip extending inwardly from the perimeter of the main body portion, the sealing lip configured to receive a sealing member to seal the opening between the body portion chamber and the finish portion chamber.

2. The container of claim 1, further comprising a plurality of circumferential ribs formed in the sidewall.

3. The container of claim 1, wherein the sealing lip is configured as a fold between the main body portion and the finish portion.

4. The container of claim 3, wherein the fold is V-shaped in transverse cross section.

5. The container of claim 4, wherein an upper segment of the fold extends upwardly at an angle of about 15 degrees relative to the reference plane.

6. The container of claim 4, wherein an upper segment of the fold has a tapered wall thickness.

7. The container of claim 4, wherein a lower segment of the fold extends downwardly at an angle of about 5 degrees relative to the reference plane.

8. The container of claim 4, wherein a lower segment of the fold has a tapered wall thickness.

9. The container of claim 4, wherein the fold extends inwardly a distance of about 5 mm from the sidewall of the main body portion.

10. The container of claim 1, further comprising a lid removably engaged to the finish portion.

11. The container of claim 10, wherein the finish portion includes a thread to threadedly engage the lid.

12. The container of claim 10, wherein the finish portion includes a ridge to snap engage the lid.

13. The container of claim 1, further comprising a sealing member secured to the sealing lip.

14. The container of claim 13, wherein the sealing member comprises a sheet of foil or film.

15. The container of claim 13, wherein the sealing member is secured to the sealing lip with an adhesive.

16. The container of claim 13, further comprising an item disposed in the finish portion chamber and isolated from the body portion chamber.

17. The container of claim 1, wherein an outer surface of the sidewall proximate the sealing lip is substantially perpendicular to the reference plane.

18. The container of claim 1, wherein the sidewall and the finish portion define a generally cylindrical shape.

19. The container of claim 1, wherein an outer surface of the sidewall is substantially aligned with an outer surface of the finish portion proximate the sealing lip.

20. The container of claim 1, wherein the sidewall has a maximum transverse dimension greater than a maximum transverse dimension of the finish portion.

21. The container of claim 1, wherein the main body portion includes a transition region between the sidewall and the sealing lip, the transition region including an angled transition portion extending inwardly and upwardly from an upper end of the sidewall to the sealing lip.

22. The container of claim 21, wherein the angled transition portion has a tapered wall thickness.

23. The container of claim 21, wherein the main body portion includes a radiused portion between the sidewall and the angled transition portion.

24. The container of claim 21, wherein the main body portion includes a radiused portion between the angled transition portion and the sealing lip.

25. A method of making a blow-molded plastic container, comprising:
forming a main body portion having a bottom region defining a support reference plane and an upstanding sidewall defining a body portion chamber and a perimeter of the main body portion;
forming a finish portion proximate an upper region of the main body portion opposite the bottom region, the finish portion defining a finish portion chamber and an opening in communication with body portion chamber, the finish portion configured to engage a lid member; and
forming a sealing lip between the main body portion and the finish portion, the sealing lip extending inwardly from the perimeter of the main body portion, the sealing lip configured to receive a sealing member to seal the opening between the body portion chamber and the finish portion chamber.
